(19) United States
(12) Patent Application Publication
(10) Pub. No.: US 2014/0262959 A1
(43) Pub. Date: Sep. 18, 2014

(54) SOLVENT AND ASPHALTENES SEPARATION POST SONICATION

(71) Applicant: PETROSONIC ENERGY INC., CALGARY (CA)

(72) Inventors: Art AGOLLI, Calgary (CA); Patrick Brunelle, Langdon (CA); Alfred Fischer, Calgary (CA)

(73) Assignee: PETROSONIC ENERGY INC., CALGARY (CA)

(21) Appl. No.: 14/208,611

(22) Filed: Mar. 13, 2014

Related U.S. Application Data
(60) Provisional application No. 61/790,160, filed on Mar. 15, 2013.

(51) Int. Cl. C10G 32/00; B01J 19/10

(52) U.S. Cl. CPC C10G 32/00; B01J 19/10
USPC 208/309; 422/127

(57) ABSTRACT

A system and process for solvent and asphaltene separation after sonic treatment of heavy oil feedstocks are disclosed. The separation process involves solvent selection and use of a proprietary sonic reactor which are paramount for the efficient operation of the whole process. The solvent and asphaltene separation system include portable and scalable equipment of design that may allow optimal recover of recyclable solvent, deasphalted oil that may be practically free of solvent and asphaltenes, and high extraction of asphaltenes in the heavy oil feedstocks processed. The system and process may enable economic operation to small to medium oil producers.

### CROSS REFERENCE TO RELATED APPLICATIONS

This application claims priority to U.S. Provisional Patent Application Ser. No. 61/790,160, filed Mar. 15, 2013, entitled “Solvent and Asphaltenes Separation Post Sonication,” which is hereby incorporated by reference in its entirety.

### BACKGROUND

1. Field of the Disclosure

The present disclosure relates generally to treatment of heavy oil feedstocks and more particularly, to a system and process for solvent and asphaltenes separation after application of sonic treatment.

2. Background Information

Refineries may not always be well suited for processing different types of heavy oil feedstocks. Viscosity, density, asphaltenes, heavy metals, sulfur and other impurities in those feedstocks demand processing to modify and/or upgrade their chemical properties. Upgrading is required to make them suitable for transportation, value optimization, and to allow refining for product yield.

The increasing demand for petroleum products has moved the oil industry towards using heavy oil feedstocks, but producers continue to face processing problems and higher costs. Current refining processes for heavy oils are more expensive than processes for light oil feedstocks. Refineries are required to process large volumes of heavy oil to equate to the same volume of final products. Additionally, the industry faces more stringent regulations imposed by government authorities regarding the specifications for fuels and environmental issues.

Existing art has seen significant advances in technology focusing on upgrading by reducing viscosity, sulfur, metals, and asphaltene content in heavy oil feedstocks. As known, upgrading of heavy oil or bitumen has problems. One of those problems relates to the fact that asphaltenes and heavy fractions have to be removed to create value and product yield. Besides, residues formed in the processing are undesirable waste materials that cannot be removed by conventional methods, thus reducing the overall yield of valuable hydrocarbon materials from the upgrading process. Removal of asphaltenes from heavy oil feedstocks and refinery residues per existing art has resulted in large ratios of solvent to heavy crude oil (HCO) or solvent to residues ratios. Moreover, the related processing is less efficient because it involves costly processing times.

Since existing upgrading technology cannot address upstream upgrading on smaller scales and because viability of upgrading is constantly changing due to production mix, refining infrastructure costs, and oil pricing, there is a need for a system and process for economically upgrading heavy oil achieving optimal solvent ratios to heavy oil, asphaltenes and residues, as well as more efficient processing times.

### SUMMARY

Present disclosure may provide a system and process for economically upgrading heavy oil feedstocks from small and medium producers right in the field and may add value and allow producers to capture a larger share for refinery products. The system and process for upgrading heavy oil feedstocks may also provide operating plants to heavy oil producers to eliminate issues related to transportation of crude oil to pipelines and refineries.

The system and process for solvent and asphaltene separation post sonication may be applied to a plurality of heavy oil feedstocks including but not limited to HCO, bitumen, and oil sands amongst others and may involve different processing stages for the removal of asphaltenes, sulfur, heavy metals, and other impurities, as well as stages for the optimal recovery and recycling of a plurality of solvents that may be used in the upgrading process.

Stages in the process may include the utilization of a plurality of technologies to process the asphaltenes, residue, and solvent to recover deasphalted hydrocarbons, asphaltenes, residues and solvents. The process may recover solvent from the deasphalted oil (DAO) and the solvent-saturated asphaltenes and residues.

The primary process of solvent deasphalting may dissolve the heavy oil feedstock in a solvent that may be selected according to the type of heavy oil feedstock to be processed and which may insure the appropriate dissolution of the oil-soluble components of the heavy oil feedstock to form DAO while the insoluble components, the asphaltenes and residues, may be filtered through simple separation using a plurality of process technologies.

Asphaltenes, residue, solvent and DAO may be separated inside the chamber of at least one proprietary sonic reactor. The sonication process that may be applied by the proprietary sonic reactor may include the application of low-frequency, high-amplitude, high energy for an optimal mass transfer. The sonication process may significantly reduce processing time from about six to ten hours (or more) to about a range between five seconds and two minutes depending on the solvent-feedstock mixture being processed and whether batch or continuous production modes are enabled.

Solvent recovery may involve stages of solvent recovery from the DAO formed post sonication by means of standard solvent recovery processes such as evaporation or distillation column amongst others, and solvent recovery from the asphaltenes and residues which may sediment after sonication, and which may be subject to heating for subsequent separation in vessels from where remnant solvent and DAO may be extracted to improve the process of solvent recovery and DAO extraction. In this process, about 95% of asphaltenes in the heavy oil feedstock may be separated.

The system and process of solvent and asphaltene separation post sonication may provide recovery results of about 92% of the solvent or higher in the initial mix with heavy oil feedstock prior to sonication, leaving a solvent residual in the oil within a range of about 4% to about less than 2%. This solvent residual in the oil may be within the expected quality parameters for pipeline transportation and refinery specifications. The solvent recovered may be reused and recycled with added new solvent for the continuous process of production of DAO and removal of asphaltenes and residues. Asphaltenes and residues removed from the heavy oil feedstock may be converted into emulsified fuel, or used for the production of road asphalt, or used as heavy fuel oil.

Utilization of the system in which the process of solvent and asphaltenes separation post sonication may be enabled may provide advantages such as lower solvent to DAO ratio, better economics, and a totally different scale because the equipment that may be required for the upgrading process and solvent and asphaltenes separation may be considered a portable system, faster and scalable. Current technology is not scalable and it is designed to work in very large refineries of a scale of about 50,000 barrels using many acres of land, while the equipment described herein may be set up in as low of an acre of land. Additionally, the resulting lower solvent to DAO ratio may make the process a more compact and smaller process that may be affordable for small and medium producers currently facing high costs due to the needed blending for pipeline transportation or penalties for failure to meet pipeline specifications, as well as the opportunities in markets where upgrading asphalt byproducts may reach premium prices.

In one embodiment, a method for separating solvents and asphaltenes comprises: combining heavy oil feedstock with a solvent to form a mixture; performing sonication on the mixture using a sonic reactor to separate deasphalted oil containing the a first portion of the solvent from asphaltenes and a second portion of the solvent; processing the deasphalted oil containing the first portion of the solvent to recover the solvent from the deasphalted oil; and processing the asphaltenes and the second portion of the solvent to recover the solvent from the asphaltenes.

In another embodiment, a method for separating solvents and asphaltenes comprises: combining heavy oil feedstock with a solvent to form a mixture; performing sonication on the mixture using a sonic reactor to separate deasphalted oil including the a first portion of the solvent from asphaltenes and a second portion of the solvent; processing the deasphalted oil including the first portion of the solvent to recover the solvent from the deasphalted oil; processing the asphaltenes and the second portion of the solvent to recover the solvent from the asphaltenes; collecting the solvent recovered from the deasphalted oil and the asphaltenes; combining a second batch of heavy oil feedstock with the recovered solvent.

In another embodiment, a solvent and asphaltene separation system comprises: an in-line mixer configured to receive heavy oil feedstock and solvent and mix the heavy oil feedstock and solvent to form a homogeneous mixture; a sonicator connected to the in-line mixer and configured to receive the homogeneous mixture from the in-line mixer and apply a low-frequency, high-amplitude, high-vibrational energy to the homogeneous mixture to separate deasphalted oil including a first portion of the solvent from asphaltenes including a second portion of the solvent; a splitter configured to receive the separated deasphalted oil including the first portion of the solvent from asphaltenes including the second portion of the solvent, direct the deasphalted oil including the first portion of the solvent to a first feedline, and direct the asphaltenes including the second portion of the solvent to a second feedline; a heat separator vessel connected to the second feedline and configured to receive the asphaltenes including the second portion of the solvent and separate the asphaltenes from the second portion of the solvent by causing the solvent to evaporate; and a separator connected to the first feedline and configured to receive the deasphalted oil including the first portion of the solvent and separate the deasphalted oil from the solvent.

Numerous other aspects, features of the present disclosure may be made apparent from the following detailed description, taken together with the drawing figures.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 depicts a process flowchart for solvent and asphaltenes separation after sonication, according to an embodiment of present disclosure.

FIG. 2 shows graphics of % asphaltene curves that may be employed in solvent selection for optimal processing of heavy oil feedstocks and solvent and asphaltenes separation post sonication, according to an embodiment of present disclosure.

FIG. 3 illustrates a process flow diagram of the system for solvent and asphaltenes separation after sonication, according to an embodiment of present disclosure.

FIG. 4A depicts an isometric view of a sonicator, according to an embodiment of present disclosure.

FIG. 4B depicts a front view of a sonicator, according to an embodiment of present disclosure.

FIG. 4C depicts a sectional view of a sonicator, according to an embodiment of present disclosure.

FIG. 4D depicts a second sectional view of a sonicator, according to an embodiment of present disclosure.

### DETAILED DESCRIPTION

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or other changes may be made without departing from the spirit or scope of present disclosure.

### DEFINITIONS

As used herein, the following terms may have the following definitions:

“Heavy oil feedstock” may refer to materials that contain heavy oil with a gravity of less than 12 API.

“Asphaltenes” may refer to materials, present in heavy oils and bitumens, which precipitate in n-alkanes solvent.

“Sonication” may refer to any device or system which produces vibrational energy sufficient to impact one or more desired end uses.

### DESCRIPTION OF THE DRAWINGS

Solvent and Asphaltenes Separation Process

FIG. 1 depicts a flowchart of a separation process 100 where solvent and asphaltenes separation after sonication may be enabled according to present disclosure.

Process provided in present disclosure may initiate with a heavy oil feedstock step 102 and a solvent selection step 104. In the heavy oil feedstock step 102, a plurality of heavy oil feedstocks, such as oil sands, bitumens, and heavy oils amongst others, may be selected for deasphalting. In the solvent selection step 104, a plurality of alkane containing non-polar solvents, including but not limited to solvents with 2 to 12 carbon numbers amongst others, may be employed. Solvent may be used in an appropriate ratio to the volume of selected heavy oil feedstock to be processed. Solvent ratios may be determined from the level of chemicals contained in selected heavy oil feedstock, desired level of separation of asphaltenes, and cost factors associated with separation process 100 and market demands.

The process may be directed to removal of asphaltenes, sulfur, heavy metals, and other impurities, and optimal recovery and recycling of the plurality of solvents that may be used in the separation process 100. After solvent may have been selected, in an in-line mixing step 106, the heavy oil feedstock may be statically or dynamically combined with solvent to form a stable and optimized mixture which may present the required blending/homogenization for an efficient sonication step 108.

In the sonication step 108, the mixture of heavy oil feedstock-solvent may be subjected to sonication with low frequency, high amplitude, high vibrational energy. The sonication step 108 may enable recovery of deasphalted hydrocarbons containing solvent and asphaltenes, residues and solvents. The quantities and properties of the separated asphaltenes and residues may depend on the temperature and nature and quantities of the solvent selected to produce an optimal efficiency of the recovered deasphalted hydrocarbon liquids. The sonication process may significantly reduce processing time from about six to ten hours (or more) to about a range between 5 seconds and two minutes depending on the solvent-feedstock mixture being processed and whether batch or continuous production modes are enabled. Asphaltenes, residue, solvent and DAO may be separated inside the chamber of at least one proprietary sonic reactor. The sonication process that may be applied by the proprietary sonic reactor may provide an optimal mass transfer.

The process may continue with processing of deasphalted hydrocarbon liquids in a DAO-solvent step 110 and processing of separated asphaltenes and residues in a asphaltenes-solvent step 112. Processing in the DAO-solvent step 110 and the asphaltenes-solvent step 112 may include the utilization of a plurality of technologies that may lead to recover solvent from the separated DAO and the solvent-saturated asphaltenes and residues. A solvent recovery step 114 may include distillation of the separated DAO to recover solvent that may be added to solvent recovered from the asphaltenes and residues. Subsequently, in a DAO step 116 and a asphaltene step 118, upgraded DAO and asphaltenes which may be filtered through simple separation may result in the proportions determined by the selection of solvent, desired level of separation of asphaltenes, and cost factors associated with separation process 100.

Depending on the production mode, either a batch or continuous mode, at an end-of-process step 120, recovered solvent may be further cleaned to recycle as shown in solvent makeup step 122, where additional solvent may be added to maintain the volume required for the appropriate solvent ratio to continue processing the heavy oil feedstock. Processed DAO may be made available to oil markets for further processing in a DAO refining step 124 and asphaltenes may be made available for conversion into asphalt road and/or heavy oil fuel in an asphaltenes conversion step 126.

Asphaltene Curves for Solvent Selection

FIG. 2 shows graphics of asphaltene curves 200 that may be employed in solvent selection for optimal processing of heavy oil feedstocks and solvent and asphaltenes separation post sonication, according to an embodiment of present disclosure.

The type of heavy oil feedstock may affect the desired asphaltene-DAO ratio that may be optimized according to principles in the present disclosure because there are heavy oil feedstocks with high asphaltene content, or low asphaltene content. Consequently, DAO and asphaltenes that may be obtained at the end of the separation process 100 may contain a desired percentage of solvent that may not be recycled.

Solvent selection may depend on the heavy oil feedstock to ensure that at the end of separation process 100 a preferred range of about 90% or higher volume of solvent may be recovered, as well as 95% asphaltenes may be removed from the heavy oil feedstock to be processed. Solvent may be recycled at an optimal recovered volume which may also require that a high reactive solvent be selected taking into consideration economical factors such as cost of the selected solvent. A heavy oil feedstock with low asphaltene content may be mixed with a low cost solvent.

A plurality of asphaltene curves 200 may be employed for solvent selection. For solvent selection, FIG. 2A shows % asphaltene-type of solvent curve 202, FIG. 2B shows % asphaltene-extraction time curve 204, and FIG. 2C shows % asphaltene-solvent ratio curve 206. All of these curves may be available for different type of heavy oil feedstocks.

As the separation of asphaltenes may be achieved by sonication of a concentrated solution of the heavy oil feedstock in n-alkane solvent, the quantities and properties of separated asphaltenes may depend on the temperature, nature, and quantity of solvent that may be used. It is known in the art that solvent power and precipitate-forming efficiency of many hydrocarbon liquids have been investigated and compared. First, the % asphaltene-type of solvent curve 202 may help to determine a level of asphaltene yield when using different n-alkane solvents. For the specific case depicted by FIG. 2A, the precipitate yield may be higher when propane is used and may decrease rapidly at first and then more gradually when increasing carbon number solvents may be used.

The ability of a solvent to solubilize asphaltene or, in general, to dissolve a solid or to form an homogeneous solution with another liquid may be expressed in terms of solubility parameters. Each of the plurality of solvents that may be used according to principles in the present disclosure have a set of solubility parameters that provide a % asphaltene yield depending on the type of heavy oil feedstock.

The % asphaltene-type of solvent curve 202 may be used in conjunction with the % asphaltene-extraction time curve 204, and the % asphaltene-solvent ratio curve 206 for prediction of optimal results according to principles in present disclosure. Predictive measures may lead to selection of a specific solvent, a solvent ratio, as well as the level of treatment during sonication with deasphalting times in the range from two minutes to about 5 seconds.

The temperature for the separation process 100 may depend on the type of solvent selected. It may be a main driver for the separation of the solvent from DAO. The lighter solvent that may be used, the lower temperature separation process 100 may operate on because a lighter solvent is a gaseous material that automatically comes up. If solvent is hexane or pentane-hexane, it is a quasi liquid that may require more heat to boil off during stages of solvent recovery step 114.

If a lighter solvent may be selected at the beginning of the separation process 100 because a heavy oil feedstock with low asphaltene content is to be processed, then the whole separation process 100 may run at a lower temperature, less heat and function, as well as a higher ratio of asphaltenes may be generated depending on economical factors that may relate to the differential between the price of the DAO and the price of the asphaltenes. This differential may become a large determinant factor to consider. Additionally, if less asphaltenes as possible may be desired at the end of the process, then a harsher solvent may be used and the whole separation process 100 may tend to operate in a higher temperature level.

The heavy oil feedstock and solvent may mix before the sonication to ensure the optimal and stable mixture for a faster, more instant reaction.

Solvent and Asphaltenes Separation System

FIG. 3 illustrates a process flow diagram of solvent and an asphaltene separation system 300 that may be employed for solvent and asphaltenes separation post sonication, according to an embodiment of present disclosure.

Heavy oil feedstock may be fed into the proprietary sonicator 302 by means of a feedline 306 and an in-line mixer 308 from a heavy oil feedstock reservoir 304, which may be minable or in situ. Solvent may come into the in-line mixer 308 when fed from a recycled solvent tank 310. Solvent and heavy oil feedstock may be dynamically mixed in the in-line mixer 308 to provide a stable and homogeneous mix that may be optimized for the sonication process. From the in-line mixer 308, the mixture solvent-heavy oil feedstock is directed into the chamber of the sonicator 302 where low-frequency, high-amplitude, and high vibrational energy may be applied during a range of time from about 5 seconds to about two minutes. Energy inputs that may be required for a 20 KW to 50 KW proprietary sonicator 302 may be in a range of about 90 KW/m³ of reactor volume, which is also equivalent to 450 HP for every 1,000 gallons. The high power input that may be required to optimize the sonication process may be of an order of 10 to 1000 times greater than results reached when energy intensive industrial mixing systems such as flotation cells or standard agitation systems amongst others are used for separation of solvent and asphaltenes. Additionally, the efficiency of the solvent and asphaltene separation system 300 for solvent and asphaltenes separation post sonication may be improved with the proprietary solvent selection process which take into account the chemical properties of n-alkanes solvents and heavy oil feedstock to determine the appropriate solvent, ratio, and sonication time.

The output from the sonicator 302 may be fed into a splitter 312 from where the separated materials may be directed into different processing to obtain the desired solvent and asphaltene separation post sonication. The distance of a feedline 314 between the sonicator 302 and the splitter 312 may be critical to prevent hardening of separated asphaltenes which may clog the feedline 314. Split materials, DAO and solvent may flow through a DAO-solvent feedline 316, and solvent-saturated asphaltenes, residues, and heavy metals may flow through an asphaltene-solvent feedline 318 after having sedimented at the bottom of the splitter 312. Depending on the design of the splitter 312, 20% of heavy oil feedstock may go as DAO and solvent and 80% of heavy oil feedstock may go as solvent-saturated asphaltenes, residues and heavy metals.

The solvent-saturated asphaltenes, residues and heavy metals in the asphaltene-solvent feedline 318 may be subsequently fed to a heater 320 where limited temperature may be applied without causing cooking. From the heater 320 solvent-saturated asphaltenes, residues and heavy metals may be sent to a heat separator vessel 322 which may include a load control 324 and a flow valve 326. The heat separator vessel 322 may dry up extra DAO and solvent which may be fed to the DAO-solvent feedline 316, and asphaltenes, residues, and heavy metals may drop at the bottom from where they are fed into a heat exchanger 328 for cooling, adjusting temperature from about 250° C. to 150° C. and subsequent storing into a storage (not shown) in an asphaltene staging 330 from where may be taken for processing into emulsification equipment (not shown) for conversion into fuel or made available to road asphalt markets. Composition of materials that may drop at bottom of the heat separator vessel 322 may be 95% asphaltene.

All recovered DAO and solvent in the DAO-solvent feedline 316 is fed to a heater 332 which may subsequently send DAO and solvent to a separator 334, which may be pressure vessels, or vacuum or steam stripping separators amongst others that may achieve high level of separation. Different quantities of DAO and solvent may be obtained in the separator 334. The quantities and qualities that may be obtained depend on the size of the separator 334 and the steps of separation that may be involved. In a two-step separator 334, during the first step employing a flash drum may result in recovery of about 50% solvent, while the second step may employ vacuum or steam distillation which may result in a level of recovery that may be greater than 90% solvent to provide DAO without solvent. Low molecular weight solvent recovered during processing in the separator 334 may be sent to a heat exchanger 336 for cooling and then sent to a solvent cleanup vessel 338. Additionally, aromatic, paraffinic, or high molecular weight solvent that may be recovered at the bottom of the solvent cleanup vessel 338 may be added to the DAO extracted from the separator 334.

Output solvent from the solvent cleanup vessel 338 may be fed to a heat exchanger 340 for a second cooling stage before it may be sent to the solvent tank 310, where a load control 342 and a flow valve 344 may act to supply about 10% makeup solvent volume that may be added from a solvent storage tank (not shown) in a solvent staging 346 to solvent recovered to maintain the volume and solvent ratio that may be required to continue processing heavy oil feedstock in solvent and the asphaltene separation system 300.

DAO from the separator 334 may be sent to storage tanks (not shown) in a DAO staging 348 from where may be available to refineries via pipelines or for other oil markets.

In addition to the type of solvent that may be employed, the heat separator vessel 322, the separator 334, and the solvent cleanup vessel 338 may be important subsystems in enabling the capability of reusing recovered solvent, which may be neither aromatic nor paraffinic for optimal efficiency of the process for solvent and asphaltenes separation post sonication. Heat temperatures that may be needed at the various stages and energy inputs required to get the separation done may provide the desired quality of the product to have less than 5% solvent in the DAO, as well as the optimal removal of asphaltenes, residues and heavy metals from the heavy oil feedstock.

Sonicator Diagram

FIG. 4A shows an isometric view 402 of the sonicator 400. FIG. 4B shows a front view 404, FIG. 4C depicts a right plane section 406, and FIG. 4D depicts a front plane section 408.

The sonicator 400 is shown having a support structure 410, a resonant bar 412, and a set of magnet configuration 414, a resonant bar supports 416, and a reaction chamber 418 on each end of the resonant bar 412.

Sonicator 400 which may be used for the solvent and asphaltene separation process 100, according to principles in present disclosure.

Sonicator 400 may use the support structure 410 to hold the resonant bar 412 in place using any suitable support as the resonant bar supports 416. Suitable configurations for the resonant bar supports 416 may include configurations including three or more rubber air cushions. Any suitable magnet configuration 414, activated by a control module (not shown), may cause the resonant bar 412 to vibrate, sonicating heavy oil feedstock in one or more reaction chambers 418. Suitable configurations for the magnet configuration 414 include configurations with at least three magnets and power suitable to cause the resonant bar 412 to vibrate.

Heavy oil feedstock in the reaction chamber 418 may have previously been chemically altered to allow the upgrading of heavy oil feedstock in the reaction chamber 418, methods for preparing it for such including the addition of one or more solvents.

The period of time needed to upgrade heavy oil feedstocks in the reaction chamber 418 may vary in dependence with a number of factors, including the amplitude and frequency of the vibration of the resonant bar 412. The amplitude and frequency of the vibration of the resonant bar 412 may in turn depend on the mass of the resonant bar 412 and the mass of the reaction chamber 418.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

The embodiments described above are intended to be exemplary. One skilled in the art recognizes that numerous alternative components and embodiments that may be substituted for the particular examples described herein and still fall within the scope of the invention.

What's claimed is:

1. A method for separating solvents and asphaltenes comprising:
combining heavy oil feedstock with a solvent to form a mixture;
performing sonication on the mixture using a sonic reactor to separate deasphalted oil including the a first portion of the solvent from asphaltenes including a second portion of the solvent;
processing the deasphalted oil including the first portion of the solvent to recover the solvent from the deasphalted oil; and
processing the asphaltenes including the second portion of the solvent to recover the solvent from the asphaltenes.

2. The method of claim 1, further comprising:
selecting a solvent from a plurality of alkane including non-polar solvents.

3. The method of claim 2, wherein the solvent is selected based on the amount of asphaltenes in the heavy oil feedstock.

4. The method of claim 1, wherein an amount of solvent mixed with the heavy oil feedstock maintains a predetermined ratio with the heavy oil feedstock based on the level of chemicals contained in the heavy oil feedstock, a designated level of separation of asphaltenes, cost factors associated with the separation process, and market demands.

5. The method of claim 1, wherein the quantity and property of the asphaltenes separated from the mixture depend on the temperature, nature, and quantities of the solvent.

6. The method of claim 1, wherein the sonication is performed for 5 seconds to 2 minutes based on the solvent and the heavy oil feedstock included in the mixture.

7. The method of claim 1, wherein sonication applies a low-frequency, high-amplitude, and high-vibrational energy to the mixture.

8. The method of claim 1, wherein processing the deasphalted oil including the first portion of the solvent to recover the solvent from the deasphalted oil comprises:
distilling the deasphalted oil to recover the solvent.

9. The method of claim 8, wherein the temperature of the distillation depends on the solvent.

10. The method of claim 9, wherein the temperature of the distillation is lower for a lighter solvent than the temperature of the distillation for a heavier solvent.

11. A method for separating solvents and asphaltenes comprising:
combining heavy oil feedstock with a solvent to form a mixture;
performing sonication on the mixture using a sonic reactor to separate deasphalted oil including the a first portion of the solvent from asphaltenes and a second portion of the solvent;
processing the deasphalted oil including the first portion of the solvent to recover the solvent from the deasphalted oil;
processing the asphaltenes and the second portion of the solvent to recover the solvent from the asphaltenes;
collecting the solvent recovered from the deasphalted oil and the asphaltenes;
combining a second batch of heavy oil feedstock with the recovered solvent.

12. The method of claim 11, further comprising:
adding additional solvent to the collected solvent based on a volume ratio with the heavy oil feedstock.

13. The method of claim 11, wherein the sonication is performed for 5 seconds to 2 minutes based on the solvent and the heavy oil feedstock included in the mixture.

14. The method of claim 11, wherein sonication applies a low-frequency, high-amplitude, and high-vibrational energy to the mixture.

15. A solvent and asphaltene separation system comprising:
an in-line mixer configured to receive heavy oil feedstock and solvent and mix the heavy oil feedstock and solvent to form a homogeneous mixture;
a sonicator connected to the in-line mixer and configured to receive the homogeneous mixture from the in-line mixer and apply a low-frequency, high-amplitude, high-vibrational energy to the homogeneous mixture to separate deasphalted oil including a first portion of the solvent from asphaltenes including a second portion of the solvent;
a splitter configured to receive the separated deasphalted oil including the first portion of the solvent from asphaltenes including the second portion of the solvent, direct the deasphalted oil including the first portion of the solvent to a first feedline, and direct the asphaltenes including the second portion of the solvent to a second feedline;
a heat separator vessel connected to the second feedline and configured to receive the asphaltenes including the second portion of the solvent and separate the asphaltenes from the second portion of the solvent by causing the solvent to evaporate; and
a separator connected to the first feedline and configured to receive the deasphalted oil including the first portion of the solvent and separate the deasphalted oil from the solvent.

16. The solvent and asphaltene separation system of claim 15, further comprising:
a first heater that heats the asphaltenes including the second portion of the solvent in the second feedline before the asphaltenes including the second portion of the solvent before the asphaltenes including the second portion of the solvent enter the heat separator vessel.

17. The solvent and asphaltene separation system of claim 16, wherein the heater does not cook the asphaltenes including the second portion of the solvent.

17. The solvent and asphaltene separation system of claim 15, further comprising:
a heat exchanger connected to the heat separator vessel and configured to cool the asphaltenes.

18. The solvent and asphaltene separation system of claim 15, wherein the separator is a two-stage separator comprising:
a flash drum performing the first stage; and
a vacuum or steam distillation performing the second step.

19. The solvent and asphaltene separation system of claim 15, further comprising:
a solvent cleanup vessel connected to the heat separator vessel and the separator and configured to clean the solvent before the solvent is recycled.

20. The solvent and asphaltene separation system of claim 19, further comprising:
a solvent staging area configured to receive recycled solvent from the solvent cleanup vessel, receive additional solvent from a solvent storage tank to maintain a predetermined solvent to heavy oil feedstock ratio, and provide solvent to the in-line mixer.

21. The solvent and asphaltene separation system of claim 15, wherein sonic reactor applies a low-frequency, high-amplitude, high-vibrational energy for 5 seconds to 2 minutes based on the solvent and the heavy oil feedstock included in the homogeneous mixture.
